(19) United States
(12) Patent Application Publication
(10) Pub. No.: US 2005/0163689 A1
(43) Pub. Date: Jul. 28, 2005

(54) Filter elements

(76) Inventors: David A Akerman, Manchester (GB); Morio Yamada, Tokorozawa-City (JP)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/512,106

(22) PCT Filed: Apr. 23, 2003
(86) PCT No.: PCT/GB03/01695

(30) Foreign Application Priority Data
Apr. 23, 2002 (GB) 0209183

(51) Int. Cl. B01D 46/00

(52) U.S. Cl. 423/177; 55/523

(57) ABSTRACT

A filter element used for gas filtration, having a composite homogenous structure of inorganic fibers and reactant, the reactant reacting either physically or chemically with contaminants in waste gas passed there through in order to remove the contaminants and thereby enabling the filtered gas to be more safely released into the atmosphere.

### FIELD OF THE INVENTION

The present invention relates to filter elements and in particular, but not exclusively, to hollow elongate porous filter elements used for gas filtration.

Waste gas from industrial processes such as municipal waste incinerators is filtered to remove contaminants such as dioxins, furans, nitrous oxides, dust, soot and other toxic and noxious substances, thereby enabling the waste gases to be more safely released into the atmosphere. Traditionally gaseous pollutants have been removed by a process of gas ‘scrubbing’ by injecting a reactant particulate material into the waste gas which reacts either chemically and/or physically with the gaseous pollutants to produce a particulate reaction product. The waste gas containing the reaction product is then filtered through a barrier filter such as a textile, metal or ceramic medium, with the reaction product and any solid pollutants present being retained as a dust cake on the surface of the filter. This has the disadvantage that it involves the handling and injection of a powder or slurry reactant material and the subsequent removal of the dust cake from the surface of the filter. The dust cake is usually removed by back-pulsing clean air under pressure through the filter which results in an increase in energy requirements for cleaning and for filtration. This is because the dust cake presents a pressure drop penalty as it provides a more impermeable layer to the gas flow, thereby requiring extra energy to pull clean gas through the cake and filter. Furthermore, after cleaning there is no build up of reactant material at the surface of the filter, which in use would provide a reactant bed for the removal of pollutants, this enables pollutants to more readily pass untreated through the filter until the reactant layer can be built-up again.

In order to alleviate this later drawback, a method of filtration was developed as described in EP 0 573 209 (Foseco International Limited), which operates by initially passing clean air containing particulate reactant material through a rigid, porous ceramic filter. This enables a layer of reactant material to build-up on the surface of the filter before the filtration of the waste gas commences. The clean air is then replaced by the waste gas and the reaction between the gaseous contaminants and the reactant material occurs at the surface of the filter, with a subsequent build-up of reaction product as a dust cake on the filter's surface. Additional reactant material may be added to the stream of waste gas during the continuing filtration. This process still has the disadvantage that the reactant material together with formation of the dust cake on the surface of the filter presents an impermeable layer requiring additional energy to extract cleaned gas. Also, regular cleaning is still required to periodically remove the dust cake with reduced filtration efficiency after cleaning and increased possibility of untreated gas passing through the filter.

EP 0 573 209 further describes the use of activated carbon or powdered lime as a particulate reactant material to absorb gaseous contaminants such as organic chemicals and acidic gases respectively. However, activated carbon when used in this manner is in the form of a dust, which is particularly messy to handle. Activated carbon which has been used to absorb chemical contaminants is typically regenerated by heating to a high temperature in an inert atmosphere, for example nitrogen. Therefore, when activated carbon is used as a particulate reactant medium, it is not cost effective to also include other particulate reactants to remove additional contaminants, since other particulate material would be then mixed with the activated carbon, with the additional requirement for other separation procedures to isolate the other particulate material from the carbon.

EP 2 242 488 (Mitsubishi Jukogyo Kabushiki Kaisha) describes a ceramic filter coated with several layers of chemicals, such as slaked lime, calcium carbonate and calcium chloride which form a catalytic barrier to extract noxious gaseous chemicals such as hydrogen chloride and nitrogen oxides from waste gas. The filter is a fired ceramic matrix which requires a large amount of energy to produce. Furthermore, it is necessary to coat the filter at least three times, thereby requiring three separate application and subsequent drying stages, thus making the filter expensive to produce. Furthermore, the multi-layered structure would provide a resistance to flow, making it less effective as a filter and requiring additional energy to draw air therethrough. The filter would soon become blocked if additionally used to filter waste gas containing particulate matter. The coatings also present a high possibility of de-lamination during reverse pulse jet-cleaning to remove the accumulated dust cake. Furthermore, acidic vapour may degrade the lime coating causing de-lamination.

EP 648 535 (Corning Incorporated) describes a method of chemically cleaning gas using a high-density honeycomb ceramic filter having particulate reactant material embedded in its pores. The ceramic framework is formed by the extrusion of a honeycomb ceramic material to provide a high strength porous material. The process requires high temperature firing at 1350° C. to 1450° C. in order to effect fusion of the ceramic particles, followed by a separate impregnation step to insert the reactant material. The manufacturing process is therefore time consuming and requires a large amount of energy. It is described in EP 648 535 that the maximum open porosity, that is the porosity of the honeycomb filter before the reactant material is inserted, is 55%. (This value represents the proportion of the substrate volume which is not solid). The porosity of the structure will therefore be decreased upon insertion of the reactant material into the open part of its structure, leading to a decrease in the filtration characteristics rendering the filter unable to remove both chemical and particulate contaminants at the same time. The high density and thereby low porosity of such a structure only allowing the performance of one function, either absorbing gases or removing particulates.

### SUMMARY OF THE INVENTION

It is an object of the present invention to provide a filter element that may overcome or alleviate the above described drawbacks.

In accordance with one aspect of the present invention there is provided a filter element comprising a composite homogenous structure of inorganic fibers and reactant. The reactant is a substance which reacts physically, for example by adsorbing or absorbing the pollutants, or which reacts chemically to produce innocuous gaseous molecules or a particulate reaction product. The presence of reactant within the body of the filter has the advantage that the reactant is fixed into position throughout the filter body and consequently removal of the reactant and spent reactant from the surface of the filter is not required giving continuity of protection and improved efficiency of filtration, since the reactant is not accumulated on the surface blinding the filter. Also, since the reactant and spent reactant do not accumulate on the surface, it is possible to add other particulate reactants to the waste gas upstream of the filter to specifically target other pollutants, thereby increasing the number of pollutants which can be removed. The spent other particulate reactants being removed from the surface of the filter in a known manner, for example back-pulsing of air jets. Also, the even distribution of reactant throughout the filter means that the waste gas must pass many more reactant particles upon its passage through the filter when compared to the reactant being merely provided on the filters surface, thereby increasing the probability of reaction and removal of the pollutant. The reactant material also acts as a filler enabling control of the porosity of the finished filter by selection of the quantity of the reactant added. Also, the type of reactant can be selected to best serve a particular filtration application.

In a preferred embodiment the filter element is in the form of an injection-moulded formed structure. It has been found that forming the filter by a process of injection-molding provides a filter having a considerable increase in porosity, typically 70 to 80% porous due to the low density distribution of the fibers and reactant. Compare this to a maximum of 55% for fired filters such as that described in EP 648 535. The structure of the present invention has the advantage that the filter additionally provides a more efficient dust filter since it remains porous during dust cake build-up. This enables dual function of the filter in that it can eliminate particulate pollutants as well as gaseous pollutants, and requires less frequent cleaning by reverse pulse-jet with consequential decrease in down-time and energy consumption. Also, it has been found that this lower density filter produces lower density dust cake, which is much easier to remove during the cleaning cycle. The less dense filter is also less heavy making it easier to handle. The increase in porosity enabling the clean gas to be more easily drawn therethrough, further decreasing energy requirements. Also, as the filtration cycle proceeds, the low-density, highly porous filter will ‘blind’ at a much slower rate, ensuring energy consumption remains low.

The inorganic fibers may be selected from the list ceramic fibers, crystalline mineral fibers, amorphous mineral fibers, mineral wool, glass fibers and other fibers with refractory properties. Ceramic fibers may include those comprising alumina, alumino-silicate, calcium silicate or other silicates.

The reactant may be activated carbon and/or catalyst.

The catalyst may comprise at least one precious metal which may be further supported on metal oxide particles, more preferably alumina particles. The catalyst may comprise at least one precious metal oxide. Preferably the precious metal and/or oxide thereof comprises 0.1-1% of the mass of the reactant. More preferably the precious metal is at least one of the group platinum, palladium, ruthenium, aluminium, titanium, tungsten and vanadium.

The activated carbon may be in the form of a powder and/or fiber. Providing the activated carbon powder within the body of the filter eliminates the need to inject it into the waste gas stream, thereby eliminating the problems associated with handling the activated carbon in use. If it becomes necessary to reactivate the carbon, this can be achieved simply by heating the filter element in a nitrogen atmosphere to, for example at least 400° C. This would not present a problem to the ceramic structure since it is capable of withstanding temperatures of at least 800° C., thus providing a cost effective means of recycling the carbon.

The structure may additionally comprise a binder system. This has the advantage of providing structural integrity to the ceramic fiber/reactant mass. The binder system may comprise colloidal dispersion and at least one of cationically modified starch or a flocculant. The flocculant may be selected from the list poly acrylamide, anionic or cationic organics or inorganic complexes. The colloidal dispersion may be a dispersion selected from the list silica, alumina, titanium dioxide, zinc oxide or zirconium oxide.

In a preferred embodiment the filter element is a hollow, candle shaped filter element, closed at one end. This type of filter element finds application in many existing filtration apparatus. The reactant may comprise 35 to 40% (by mass) of a 1 metre filter element weighing 750 to 800 g.

In accordance with a second aspect of the present invention there is provided a method of manufacture of a filter element comprising the steps of dispersing ceramic fibers in water, adding a binder system, mixing, injection-molding to provide a filter element of the desired shape and leaving the filter element to dry, wherein method further includes the step of dispersing a reactant throughout the filter element. This method is relatively cheap since high temperature firing is not required, the injection-molding may occur at room temperature and subsequent heating at a temperature to dry the formed element. Also, forming the filter by injection-molding provides a filter of comparatively low density and consequently high porosity.

In a preferred embodiment the step of dispersing includes dispersing a reactant in said water. In a further preferred embodiment the step of dispersing said reactant includes the step of saturating the formed filter in a reactant. The reactant maybe in the form of a dilute aqueous solution or a suspension and the step of saturating may take place either before, during or after drying the filter element.

The reactant may comprise activated carbon, the filter element thus produced comprises activated carbon in an easily handled form, in that it is fixed within the body of the filter, and thus eliminates the problems associated with adding activated carbon in particulate form to a waste gas stream and also the consequential removal of spent carbon from the surface of the filter. The reactant may additionally comprise a catalyst.

The method may include the additional step of dipping the formed filter element into a dilute colloidal dispersion. Dipping may be conducted before or after the filter element has been dried.

In accordance with a third aspect of the present invention there is provided an apparatus for removing contaminants from waste gas, comprising at least one filter element formed from a homogenous structure of inorganic fibers and activated carbon, means to supply the waste gas to be filtered to the at least one filter element, and means to supply hot nitrogen gas to the at least one filter element. This has the advantage that the carbon in filter(s) can be reactivated in situ without having to remove the filter elements. In a preferred embodiment the apparatus further comprises means to heat the gas to at least 400° C.

By way of example only specific embodiments of the invention will now be described. In a first embodiment, 15 kg of alumino-silicate ceramic fiber and 2 kg activated carbon powder are dispersed in 1000 kg of water. 3.7 kg of colloidal silica (35% solids) is then added and the ingredients mixed to ensure adequate dispersion. 0.8 kg of cationic modified starch is then added as a 4% solution, after being dissolved previously in 20 kg of water. Candle-shaped filter elements, closed at one end, are formed by a process of injection-molding the slurry to provide a filter element 1 m long with an internal diameter of 35 mm. The wet candles are subsequently dried at 110° C. for eight hours to provide a finished filter element.

In a second embodiment, 10 kg of alumino-silicate ceramic fiber and 7.5 kg activated carbon powder are dispersed in 1000 kg of water. 6.81 kg of colloidal silica (35% solids) is added and the resultant solution mixed. 0.8 kg of cationically-modified starch is then added as a 4% solution (dissolved in 20 kg of water) and the resultant solution mixed at slow speed for a couple of minutes. 0.01 kg of polyacrylamide cationic flocculant is then added as 1 kg of 1% w/w solution, having been previously dissolved and prepared according to manufacturers' instructions. The resultant solution is then mixed for two minutes and candle-shaped filter elements formed as described with respect to the first embodiment.

In a further embodiment the method includes the additional step of dipping either of the filter elements formed as described above in a dilute colloidal dispersion.

Although activated carbon has been described as the reactant material for absorbing contaminants, the reactant material could be or additionally include a catalyst which acts on the contaminant to degrade them into harmless smaller molecules. The catalyst is added to the fiber slurry, in the same way as the activated carbon, and flocculated using a colloid/starch binder system. The catalyst would thus be homogeneously dispersed within the filter element, which can be formed by injection-molding as described with respect to the first embodiment.

The reactant has been described as being dispersed in the water with the ceramic fibers. However, the reactant may additionally or alternatively be applied after the filter element has been formed by way of a dilute aqueous solution or suspension, which saturates the element whereby the reactant is dispersed throughout the entire element body. This application may be immediately after injection-molding when the element is still damp, or after the drying stage.

Although specific formulae have been described, it is to be understood that other proportions of the ingredients and/or alternative ingredients could be provided to produce a ceramic filter in which the activated carbon and/or catalyst is evenly distributed throughout the structure thereof. Although activated carbon powder has been described it is to be understood the filter may alternatively comprise activated carbon fibers, or a mixture of activated carbon fibers and activated carbon powder. The type of activated carbon and/or catalyst may be chosen specifically to have a high affinity for the target gaseous chemical(s).

The presently described filter element has significantly lower energy requirements compared to known filters and it has a porosity of 75 to 80% which provides a high through put of the gas stream, even when a dust cake has built-up on the outer surface of the filter element, as well as a superior cake release due to decreased cake density, ensuring it is easily dislodged by reverse pulse-jet cleaning.

Also, the present filter element can effectively remove gaseous contaminants from a gas stream while simultaneously retaining enough permeability to function as an exceptional filter of particulates, a function not demonstrated by previously known filters. This is possible because the removal of gaseous contaminants does not impinge on the removal of particulates, and visa versa and in that the reactant material and dust cake are easily isolated for further regeneration or processing. The dust cake may be removed by conventional means such as the back pulse of a high pressure air jet. When the reactive material is activated carbon, the carbon may be reactivated by heating the filter element in a high temperature nitrogen atmosphere. In a further embodiment the filtration filter element(s) is utilised in a filtration apparatus for the treatment of waste gas, the filtration apparatus comprising means to supply high temperature nitrogen to the filter element(s) to regenerate the carbon within the filters.

Although a candle-shaped filter of a specific size has been described, it is to be understood that other sizes of candle shaped filters could be produced or alternative shaped filters could be formed by injection-molding to provide a composite filter structure of ceramic fibers and reactant material. Although ceramic fibers have been described, the filter element could be constructed from other refractory inorganic fibers or a combination thereof.

1-26. (canceled)

27. A filter element comprising a composite homogenous structure of inorganic fibers and a reactant.

28. A filter element as claimed in claim 27, wherein the filter element is a structure which has been formed by a process of injection-molding.

29. A filter element as claimed in claim 27, wherein the inorganic fibers are selected from the group consisting of ceramic fibers, crystalline mineral fibers, amorphous mineral fibers, mineral wood, glass fibers and fibers with refractory properties.

30. A filter element as claimed in claim 28, wherein the inorganic fibers are selected from the group consisting of ceramic fibers, crystalline mineral fibers, amorphous mineral fibers, mineral wood, glass fibers and fibers with refractory properties.

31. A filter element as claimed in claim 27, wherein the inorganic fibers include ceramic fibers selected from the group consisting of alumina, alumina-silicate, calcium silicate and silicates.

32. A filter element as claimed in claim 28, wherein the inorganic fibers include ceramic fibers selected from the group consisting of alumina, alumina-silicate, calcium silicate and silicates.

33. A filter element as claimed in claim 27, wherein the reactant comprises activated carbon.

34. A filter element as claimed in claim 27, wherein the reactant comprises a catalyst.

35. A filter element as claimed in claim 33, wherein the activated carbon is in the form of a powder or fiber.

36. A filter element as claimed in claim 34, wherein the catalyst comprises at least one precious metal or precious metal oxide.

37. A filter element as claimed in claim 34, wherein the catalyst comprises at least one precious metal supported on metal oxide particles.

38. A filter element as claimed in claim 36, wherein the precious metal or precious metal oxide thereof comprises 0.1 to 1% of the mass of the reactant.

39. A filter element as claimed in claim 36, wherein the precious metal or precious metal oxide is selected from the group consisting of platinum, palladium, ruthenium, aluminum, titanium, tungsten, and vanadium.

40. A filter element as claimed in claim 27, further comprising a binder system.

41. A filter element as claimed in claim 40, wherein the binder system comprises colloidal dispersion and at least one cationically modified starch or a flocculant.

42. A filter element as claimed in claim 41, wherein the colloidal dispersion contains at least one substance selected from the group consisting of silica, alumina, titanium dioxide, zinc oxide or zirconium oxide.

43. A filter element as claimed in claim 41, wherein the flocculant is selected from the group consisting of poly acrylamide, anionic or cationic organics, or inorganic complexes.

44. A filter element as claimed in claim 27, wherein the filter element is a hollow, candle shaped filter element, closed at one end.

45. A filter element as claimed in claim 27, wherein the reactant comprises 35 to 40% (by mass) of a 1 meter filter element weighing 750 to 800 g.

46. A method of manufacture of a filter element comprising the steps of:
a. dispersing ceramic fibers in water;
b. adding a binder system;
c. mixing;
d. injection-molding to provide a filter element body of the desired shape; and
e. leaving the filter element to dry, wherein the method further includes the step of dispersing a reactant throughout the body of the filter element.

47. A method according to claim 46, wherein the step of dispersing said reactant is by dispersing said reactant in said water.

48. A method according to claim 46, wherein the step of dispersing said reactant is by saturating a formed filter element in said reactant.

49. A method according to claim 48, wherein said reactant for saturating said formed filter element is applied in the form of a dilute aqueous solution or a suspension.

50. A method according to claim 48, wherein said step of saturating is performed before said step of drying.

51. A method according to claim 46, wherein the reactant comprises activated carbon.

52. A method according to claim 46, wherein the reactant comprises a catalyst.

53. A method according to claim 46, including the additional step of dipping a formed filter element into a dilute colloidal dispersion.

54. An apparatus for removing contaminants from waste gas, comprising at least one filter element formed from a homogenous structure of inorganic fibers and activated carbon, means to supply the waste gas to be filtered to the at least one filter element, and means to supply hot nitrogen gas to the at least one filter element.

55. An apparatus as claimed in claim 54, comprising means to heat the nitrogen gas to at least 400° C.
